(19) United States
(12) Patent Application Publication
(10) Pub. No.: US 2009/0040493 A1
(43) Pub. Date: Feb. 12, 2009

(54) ILLUMINATION OPTICAL SYSTEM, ILLUMINATION OPTICAL APPARATUS, EXPOSURE APPARATUS, AND DEVICE MANUFACTURING METHOD

(76) Inventor: Hideki Komatsuda, Ageo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/170,236

(22) Filed: Jul. 9, 2008

Related U.S. Application Data
(60) Provisional application No. 60/935,377, filed on Aug. 9, 2007.

(51) Int. Cl. G03B 27/54

(52) U.S. Cl. 355/67; 355/77

(57) ABSTRACT

An illumination optical apparatus includes a light source, which supplies illumination light including a wavelength of 5 nm to 50 nm, and an illumination optical system, which guides the illumination light to an illuminated surface. The illumination optical system includes an aperture angle restriction member and a condenser optical system, which is arranged in an optical path between the aperture restriction member and the illuminated surface to guide light beam from the aperture angle restriction member to the illuminated surface. A rotation axis of an arcuate-shape of an illumination region formed on the illuminated surface is located outside an opening of the aperture angle restriction member. The condenser optical system includes a plurality of reflection surfaces. Among the plurality of reflection surfaces, the reflection surface closest to the illuminated surface along the optical path includes a concave shape. When, for example, applied to an EUVL exposure apparatus, the illumination optical apparatus illuminates a reflective mask, serving as the illumination plane, without a plane mirror in the optical path between the illumination optical system and the mask.

### CROSS-REFERENCE TO RELATED APPLICATIONS

This application claims the benefit of priority from U.S. Provisional Patent Application No. 60/935,377, filed on Aug. 9, 2007.

### BACKGROUND OF THE INVENTION

The present invention relates to an illumination optical system, an illumination optical apparatus, an exposure apparatus, and a device manufacturing method. More particularly, the present invention relates to a reflection-type illumination optical apparatus optimal for use in an exposure apparatus for manufacturing devices in a lithography process, such as semiconductor, imaging, and liquid crystal display devices, and thin-film magnetic heads.

In a conventional exposure apparatus for manufacturing semiconductor devices and the like, a circuit pattern is formed on a mask (reticle) and thereafter projected and transferred onto a photosensitive substrate (e.g., wafer) through a projection optical system. A resist applied on the photosensitive substrate is photosensitized by projection and exposure performed by a projection optical system to obtain a resist pattern corresponding to a mask pattern. The resolution of the exposure apparatus is dependent on the wavelength of exposure light and the numerical aperture of the projection optical system.

In other words, the wavelength of the exposure light must be shortened and the numerical aperture of the projection optical system must be increased to improve the resolution of the exposure apparatus. It is generally difficult to increase the numerical aperture of the projection optical system to a level that is greater than or equal to a predetermined value from the viewpoint of optical design. Thus, the wavelength of the exposure light must be shortened. Accordingly, EUVL (Extreme Ultra-Violet Lithography) technique is gathering attention as a next-generation exposure method (exposure apparatus) for semiconductor patterning.

An EUVL exposure apparatus uses EUV (Extreme Ultra-Violet) light having a wavelength of about 5 to 50 nm, which is shorter that in the conventional exposure method that uses KrF excimer laser light having a wavelength of 248 nm or an ArF excimer laser light having a wavelength of 193 nm. When using EUV light as the exposure light, there is no usable light transmissive optical material. Thus, a reflection-type optical integrator, a reflective mask, and a reflection-type (catoptric) projection optical system are used in the EUVL exposure apparatus (for example, refer to patent document 1).
[Patent Document 1] U.S. Pat. No. 6,452,661

### SUMMARY OF THE INVENTION

In an exposure apparatus, to obtain the same exposure conditions (or illumination conditions), throughout an exposure region, the exit pupil of an illumination optical system is normally arranged at the same position as an entrance pupil of a projection optical system. However, an EUVL exposure apparatus uses a reflective mask. Thus, when the exit pupil of the illumination optical system is arranged at the same position as the entrance pupil of the projection optical system, the illumination optical system and the projection optical system would be arranged in the same area and thus interference with each other. In such a case, the apparatus cannot be realized.

Therefore, in a conventional EUVL exposure apparatus, a plane mirror is arranged in an optical path between the illumination optical system and a mask to deflect the optical path. However, for an EUVL exposure apparatus, the fabrication of a reflection mirror having a reflectivity of close to 100% for the used EUV light would be impossible. Further, from the viewpoint of throughput of the apparatus, it is required that the quantity of reflection mirrors be minimized.

It is an object of the present invention to provide, when applied to, for example, an EUVL apparatus, an exposure apparatus that illuminates a surface to be illuminated (illuminated surface) without arranging a plane mirror in an optical path between an illumination optical system and a reflective mask. Further, it is an object of the exposure apparatus that provides an exposure apparatus for performing exposure under satisfactory exposure conditions with the use of an illumination optical apparatus for illuminating a reflective mask that can be arranged on an illuminated surface.

To summarize the present invention, several aspects, advantages, and novel features of the present invention are described below. However, such advantages may not all be achieved in certain aspects of the present invention. In such a manner, the present invention may be practiced so as to achieve or optimize one advantage or a series of advantages without having to achieve the advantages suggested or proposed herein.

To achieve the above object, a first embodiment of the present invention is a reflection-type illumination optical system for guiding illumination light to an arcuate-shape region on an illuminated surface. The illumination optical system includes an aperture angle restriction member which is arranged in an illumination optical path and which restricts an aperture angle of light beam illuminating the illuminated surface. A reflection-type condenser optical system, which is arranged in an optical path between the aperture angle restriction member and the illuminated surface, guides the light beam from the aperture angle restriction member to the illuminated surface. The arcuate-shape has a rotation axis located outside an opening of the aperture angle restriction member. The reflection-type condenser optical system includes a plurality of reflection surfaces. Among the plurality of reflection surfaces, the reflection surface closest to the illuminated surface along the optical path is shaped to be concave.

A second embodiment of the present invention is a reflection-type illumination optical system for guiding illumination light to a region having a predetermined shape on an illuminated surface. The illumination optical system includes an aperture angle restriction member which is arranged in an illumination optical path and which restricts an aperture angle of light beam illuminating the illuminated surface. A reflection-type condenser optical system, which is arranged in an optical path between the aperture angle restriction member and the illuminated surface, guides the light beam from the aperture angle restriction member to the illuminated surface. A pupil axis extending through the center of an exit pupil of the illumination optical system perpendicular to a plane of the exit pupil is located outside an opening of the aperture angle restriction member. The reflection-type condenser optical system includes a plurality of reflection surfaces. Among the plurality of reflection surfaces, the reflection surface closest to the illuminated surface along the optical path is shaped to be concave.

A third embodiment of the present invention is an illumination optical system for guiding illumination light to an arcuate-shape region on an illuminated surface. The illumination optical system includes a first fly's eye optical system including a plurality of first mirror elements arranged in parallel. A second fly's eye optical system includes a plurality of second mirror elements arranged in parallel so that each of the second mirror elements is associated with one of the first mirror elements of the first fly's eye optical system. A condenser optical system, which guides light from each of the plurality of second mirror elements to the region having the arcuate-shape in a superimposed manner, forms a position that is conjugated to the illuminated surface in an optical path between the second fly's eye optical system and the illuminated surface.

A fourth embodiment of the present invention is an illumination optical apparatus including a light source which supplies illumination light having a wavelength of 5 nm to 50 nm and the illumination optical system according to the first, second, or third aspect to guide the illumination light from the light source to an illuminated surface.

A fifth embodiment of the present invention is an exposure apparatus for exposing a pattern arranged on an illuminated surface onto a photosensitive substrate. The exposure apparatus includes the illumination optical apparatus according to the fourth aspect.

A sixth embodiment of the present invention is a device manufacturing method including exposing a pattern onto a photosensitive substrate with the exposure apparatus according to the fifth aspect, developing the photosensitive substrate onto which the pattern has been transferred and forming on a surface of the photosensitive substrate a mask layer shaped in correspondence with the pattern, and processing the surface of the photosensitive substrate through the mask layer.

In the illumination optical systems of the above embodiments, a rotation axis of an arcuate illumination region formed in an illuminated surface or a pupil axis that extends through the center of an exit pupil and perpendicular to a plane of the exit pupil is located outside an opening of an aperture angle restriction member. As a result, when applied to, for example, an EUVL exposure apparatus, the exit pupil of an illumination optical system and the entrance pupil of a projection optical system may be located at the same position without mechanical interference between the illumination optical system and projection optical system even when a plane mirror for deflecting the optical path is not arranged between the illumination optical system and reflective mask. In other words, even when the exit pupil of the illumination optical system and the entrance pupil of the projection optical system are located at the same position, mechanical interference between the illumination optical system and the projection optical system is prevented. Further, the optical path of the illumination optical system and the optical path of the projection optical system may be prevented from being overlapped with each other.

More specifically, in the illumination optical apparatuses of the above aspects, a mask that can be arranged on the illuminated surface may be illuminated without arranging a plane mirror in an optical path between the illumination optical system and reflective mask. Accordingly, in the exposure apparatus of the above aspects, an illumination optical apparatus may be used to manufacture a device having satisfactory performance by performing exposure under satisfactory exposure conditions.

### BRIEF DESCRIPTION OF THE DRAWINGS

FIG. 1 is a schematic diagram showing the entire structure of an exposure apparatus according to one embodiment of the present invention;

FIG. 2 is a schematic diagram showing the inner structure of a light source, an illumination optical system, and a projection optical system of FIG. 1;

FIGS. 3(a) and 3(b) are schematic diagram showing an example of an optical integrator of FIG. 2;

FIG. 4 is a schematic diagram showing a single scanning exposure in the present embodiment;

FIG. 5 is a diagram showing a state in which a rotation axis of the arcuate-shape of the illumination region formed on a mask is defined by the center of a circle defined by an outer arc or an inner arc;

FIG. 6 is a schematic diagram showing the main structure of an illumination optical system according to a comparative example;

FIG. 7 is a schematic diagram showing the main structure of an illumination optical system according to a first example;

FIG. 8 is a schematic diagram showing the main structure of an illumination optical system according to a second example;

FIGS. 9(a), 9(b), and 9(c) are diagrams respectively illustrating the definitions of openings in substantial aperture stops having dipole, quadrupole, and annular-shaped openings;

FIGS. 10(a) and 10(b) are diagrams respectively illustrating the definitions of openings in substantial aperture stops; and

FIG. 11 is a flowchart showing one example of the procedures for obtaining a semiconductor device serving as a micro-device.

### DETAILED DESCRIPTION OF THE PREFERRED EMBODIMENTS

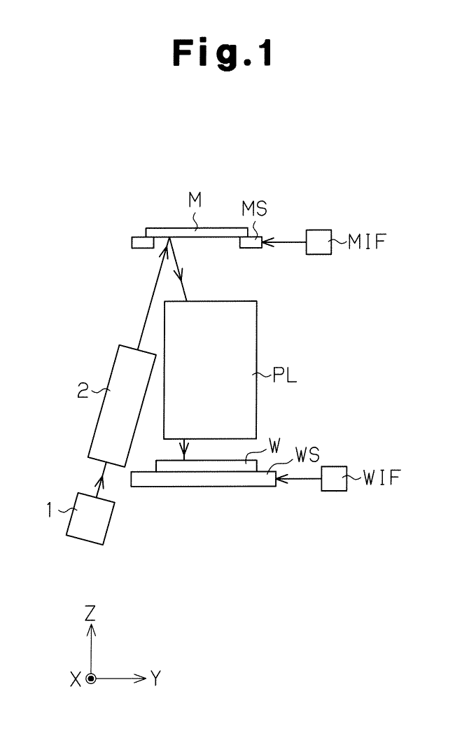

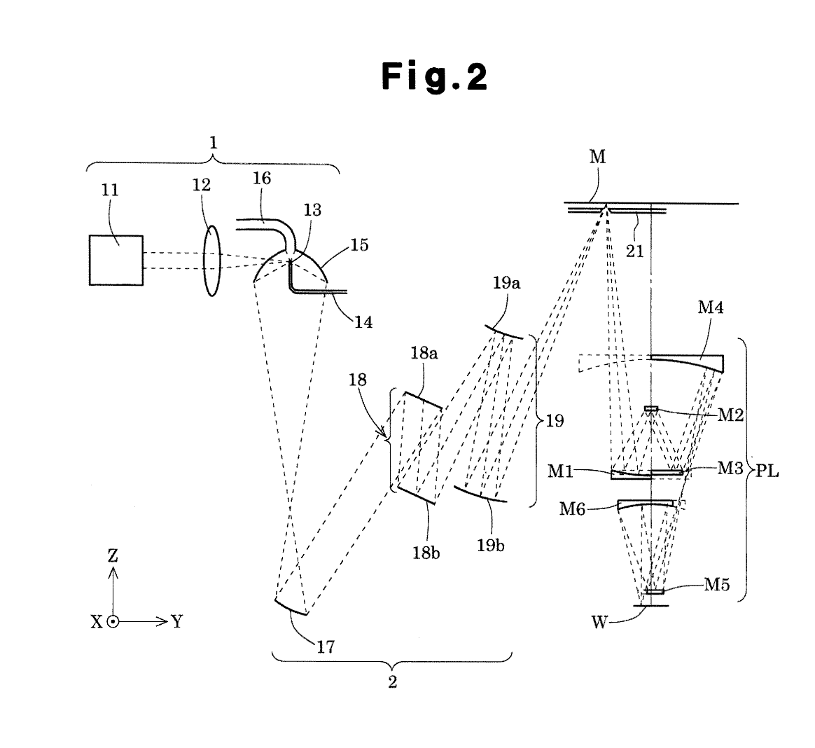

One embodiment according to the present invention will now be discussed with reference to the appended drawings. FIG. 1 is a schematic diagram showing the entire structure of an exposure apparatus according to one embodiment of the present invention. FIG. 2 is a schematic diagram showing the inner structure of a light source, an illumination optical system, and a projection optical system of FIG. 1. In FIG. 1, a Z-axis is set along an optical axis direction of the projection optical system, that is, a normal direction of a wafer, or a photosensitive substrate. A Y-axis is set in a direction parallel to the plane of FIG. 1 in the wafer surface. Further, an X-axis is set in a direction perpendicular to the plane of FIG. 1 in the wafer surface.

Referring to FIG. 1, the exposure apparatus of the present embodiment is supplied with exposure light from a light source including, for example, a laser plasma light source 1. The light source 1 emits light that enters an illumination optical system 2 through a wavelength selection filter (not shown). In the light emitted from the light source 1, the wavelength selection filter functions to selectively transmit only EUV light having a predetermined wavelength (e.g., 13.4 nm) and block light having other wavelengths. The EUV light transmitted through the wavelength selection filter illuminates a reflective mask (reticle) M having a pattern that is to be transferred through the illumination optical system 2.

The mask M is held by a mask stage MS so that the pattern surface of the mask M extends along the XY plane. The mask stage MS is movable along the Y-direction. The movement is measured by a laser interferometer MIF. The light from the pattern of the illuminated mask M forms an image of the mask pattern on a wafer W, which is a photosensitive substrate, through a reflection-type projection optical system PL. That is, an arcuate static exposure region (effective exposure region) that is symmetric with respect to the Y-axis is formed on the wafer W, as will be described later.

The wafer W is held by a wafer stage WS so that the exposure surface of the wafer W extends along the XY plane. The wafer stage WS is movable in a two-dimensional manner along the X-direction and the Y-direction. The movement is measured by a laser interferometer WIF in the same manner as the mask stage MS. In this manner, while moving the mask stage MS and the wafer stage WS along the Y-direction, that is, while moving the mask M and the wafer W along the Y-direction relative to the projection optical system PL, by performing scanning and exposing (scanning exposure), a pattern of the mask M is transferred to a single rectangular short region (exposure region) on the wafer W.

During the scan exposure, when the projection magnification (transfer magnification) of the projection optical system PL is, for example, ¼, the movement speed of the wafer stage WS is set to ¼ the movement speed of the mask stage MS to perform synchronous scanning. The pattern of the mask M is sequentially transferred to each shot region on the wafer W by repeating the scanning exposure while moving the wafer stage WS in a two-dimensional manner in the X-direction and the Y-direction.

Referring to FIG. 2, the laser plasma light source 1 shown in FIG. 1 includes a laser light source 11, a condenser lens 12, a nozzle 14, an elliptical reflection mirror 15, and a duct 16. The light (non-EUV light) emitted from the laser light source 11 is converged on a gas target 13 by the condenser lens 12. The gas target 13 is gas such as xenon (Xe) gas supplied from a high pressure gas source to the nozzle 14 and ejected from the nozzle 14. The gas target 13 obtains energy from the converged laser light. As a result, the gas target 13 becomes plasmatic and emits EUV light. The gas target 13 is positioned at a primary focal point on the elliptical reflection mirror 15.

Accordingly, the EUV light emitted from the laser plasma light source 1 converges at a secondary focal point of the elliptical reflection mirror 15. The gas that has emitted light is drawn into the duct 16 and guided outside. The EUV light converged at the secondary focal point of the elliptical reflection mirror 15 is converted to substantially collimated light beam by a concave reflection mirror 17 and guided to an optical integrator 18, which includes two fly's eye optical systems 18a and 18b.

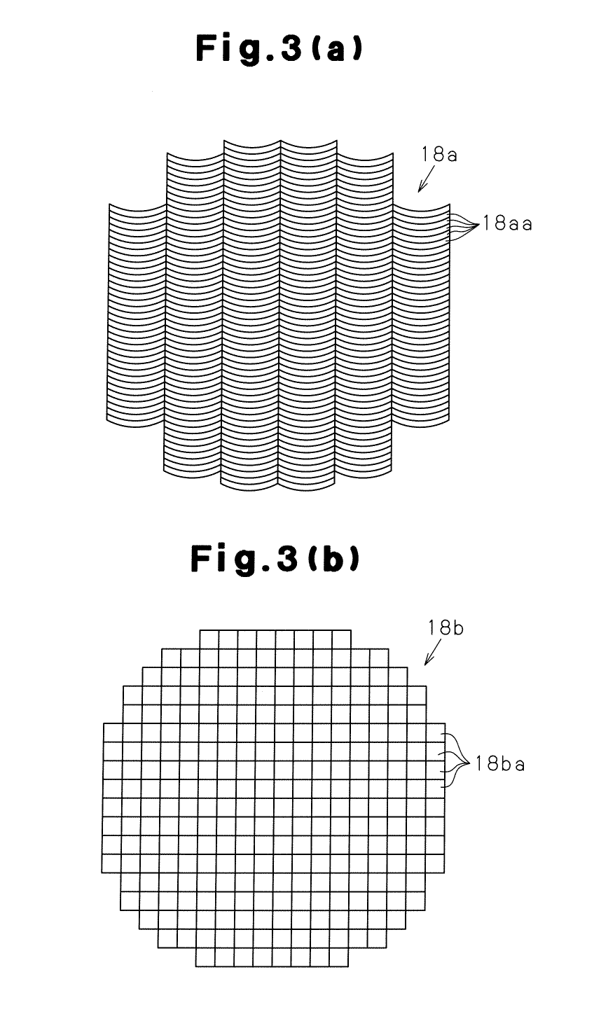

The first fly's eye optical system 18a is formed, for example, by a plurality of reflection mirror elements 18aa, which have an arcuate profile and are arranged in parallel as shown in FIG. 3(a). The second fly's eye optical system 18b is formed by a plurality of reflection mirror elements 18ba arranged in parallel, with each of the reflection mirror elements 18ba associated with one of the plurality of reflection mirror elements 18aa in the first fly's eye optical system 18a. For example, as shown in FIG. 3(b), the reflection mirror elements 18ba each have a rectangular profile and are arranged in parallel to one another. U.S. Pat. No. 6,452,661 is incorporated herein by reference to the furthest extent allowed by law to supplement the disclosure presented herein with regard to the specific structure and operation of the first fly's eye optical system 18a and the second fly's eye optical system 18b.

A substantial planar light source having a predetermined shape is formed near an emission plane of the optical integrator 18, that is, near the reflection plane of the second fly's eye optical system 18b. The substantial planar light source is formed at an exit pupil position of the illumination optical system 2, that is, at a position optically conjugated to an entrance pupil of the projection optical system PL. An aperture stop AS (not shown in FIG. 2 but will be described later) is arranged in the vicinity of the reflection plane of the second fly's eye optical system 18b, that is at the position where the substantial planar light source is formed.

Light from the substantial planar light source is emitted from the illumination optical system 2 through a condenser optical system 19 formed by a curved reflection mirror (convex reflection mirror or convex reflection mirror) 19a and a concave reflection mirror 19b. The condenser optical system 19 is formed such that the light from each of the plurality of reflection mirror elements 18ba in the second fly's eye optical system 18b illuminates the mask M in a superimposed manner. The light emitted from the illumination optical system 2, for example, passes through an arcuate opening (light transmission portion) of a field stop 21, which is arranged in the vicinity of the mask M, and forms an arcuate illumination region on the mask M. Thus, the illumination optical system 2 (17 to 19) form an illumination system for performing Köhler illumination on the mask M having a predetermined pattern.

The light from the pattern of the illuminated mask M forms an image of the mask pattern in an arcuate static exposure region on the wafer W through the projection optical system PL. The projection optical system PL includes a first catoptric optical system, which forms an intermediate image of the pattern of the mask M, and a second catoptric optical system, which forms an image of the intermediate image of the mask pattern (secondary image of the pattern of the mask M) on the wafer W. The first catoptric optical system is formed by four reflection mirrors M1 to M4, and the second catoptric optical system is formed by two reflection mirrors M5 and M6. The projection optical system PL is an optical system telecentric at the wafer side (image side).

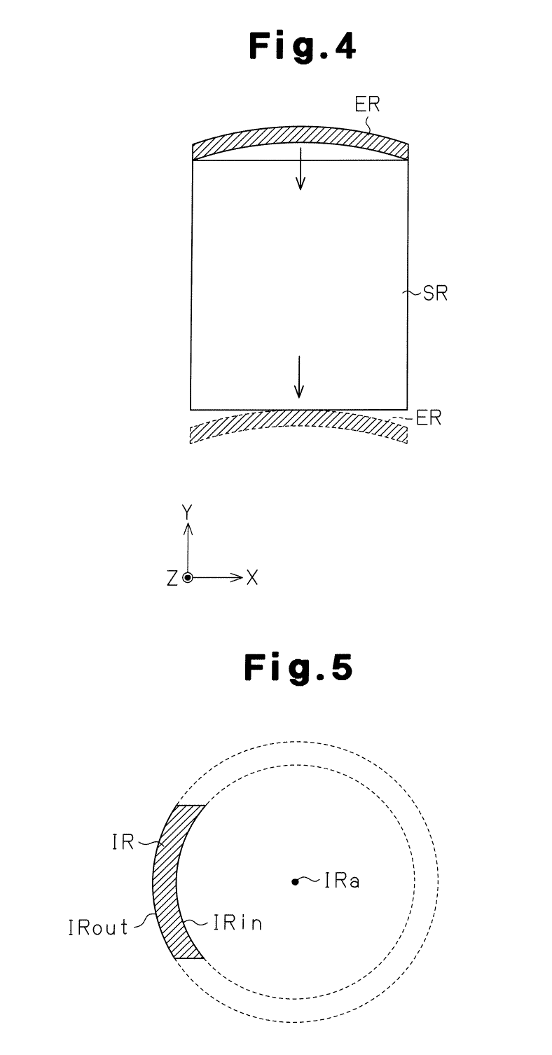

FIG. 4 is a diagram schematically illustrating a single scanning exposure in the present embodiment. With reference to FIG. 4, an arcuate static exposure region (effective exposure region) ER symmetric with respect to the Y-axis is formed so as to correspond to the arcuate effective imaging region and the effective field of the projection optical system PL in the exposure apparatus of the present embodiment. The arcuate static exposure region ER moves from a scanning start position, which is shown by solid lines in the drawing, to a scanning end position, which is shown by broken lines in the drawing, while transferring the pattern of the mask M onto one rectangular shot region SR of the wafer W during a single scanning exposure (scanning and exposing).

FIG. 5 is a diagram showing a state in which a rotation axis IRa of an arcuate illumination region IR formed on the mask M is defined by the center of a circle defined by an outer (convex side) profile line or an inner (concave side) profile line IRin. As shown in FIG. 5, the arcuate illumination region IR is formed on the mask M in correspondence with the arcuate static exposure region ER. The rotation axis Ira of the arcuate-shape of the illumination region IR is defined as the center of a circle defined by the outer profile line IRout or the inner profile line IRin. More specifically, a straight line extending through the center of a circle perpendicular to the plane of FIG. 5 is the rotation axis IRa. In the example of FIG. 5, the center of a circle defining the outer profile line IRout of the illumination region IR coincides with the center of a circle defining the inner profile line IRin. However, when the circle defining the outer profile line IRout and the circle defining the inner profile line IRin are not concentric, a median point between the centers of one of the two circles may be defined as the rotation axis IRa of the illumination region IR. Further, when the curve defining the outer (convex side) profile line of the illumination region IR or a curve defining an inner (concave side) profile line is not part of a perfect circle, for example, when the curve is part of an ellipse, the center of the ellipse may be considered as the rotation axis IRa of the illumination region. In this specification, any of such axes will be referred to as a “rotation axis of an arcuate-shape” or a “rotation axis of the illumination region.” As will be described later, the rotation axis IRa of the arcuate-shape of the illumination region IR extends through the center of the exit pupil of the illumination optical system perpendicular to a plane of the exit pupil.

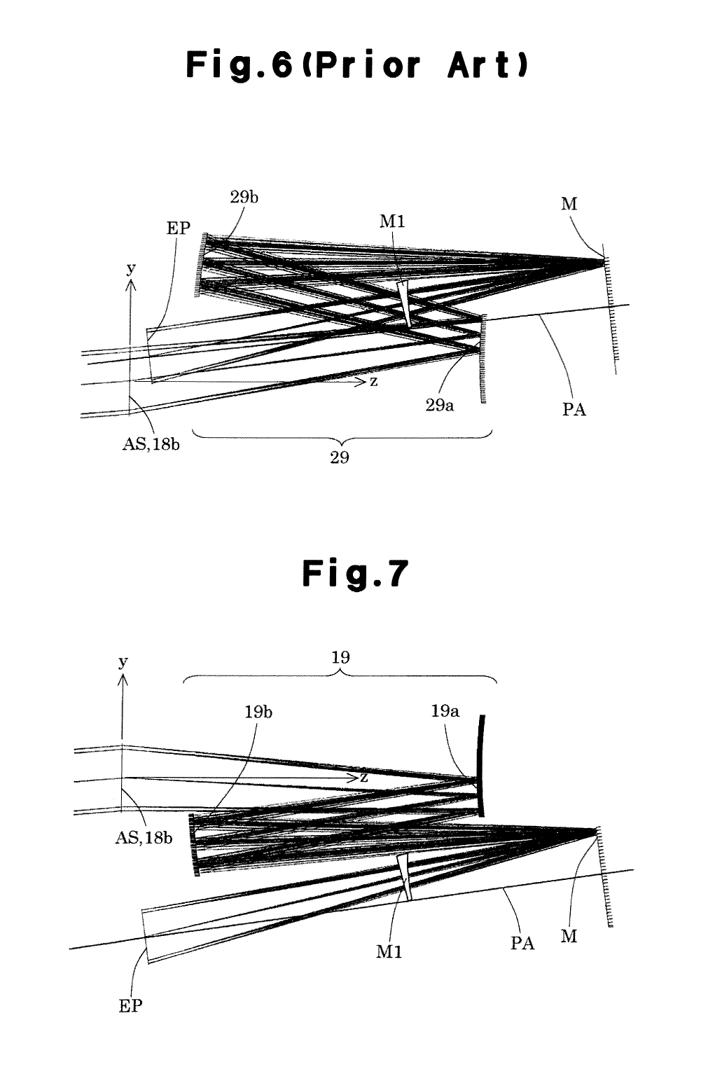

Before describing in detail the structure and operation of the illumination optical system 2 of the present embodiment, the structure and problems of a conventional illumination optical system will be discussed as a comparative example. FIG. 6 is a schematic diagram showing the main structure of the illumination optical system in the comparative example. Referring to FIG. 6, a condenser optical system 29 forming the main part of the illumination optical system in the comparative example includes a convex reflection mirror 29a and a concave reflection mirror 29b arranged in this order with respect to the light received from an aperture stop AS arranged substantially at the same position as the reflection plane of the second fly's eye optical system 18b. The example of FIG. 6 is shown without a plane mirror, which is conventionally used. Further, FIG. 6 shows an example in which the projection optical system and the illumination optical system are not separated. Further, FIG. 6 shows the reflection mirror M1 of the projection optical system PL shown in FIG. 2 that is arranged closest to the illumination optical system.

FIG. 6 shows a state in which light from an infinitely distant object (not shown) passes through the aperture stop AS and the second fly's eye optical system 18b and forms an image on the mask M after passing by the convex reflection mirror 29a and the concave reflection mirror 29b. In FIG. 6, a reference axis extending through the center of the opening (light transmission portion) of the aperture stop AS perpendicular to the surface of the aperture stop AS is defined as the z-axis. An axis perpendicular to the plane of FIG. 6 and extending along the surface of the aperture stop AS is defined as the x-axis. An axis parallel to the plane of FIG. 6 and extending along the surface of the aperture stop AS is defined as the y-axis. The setting of the coordinates (x, y, z) is the same as in each of the embodiments described below.

The values of data for the main parts of the illumination optical system in the comparative example are shown in table (1). The data of table (1) is listed in accordance with the format “Code V”, which is an optical designing software manufactured by ORA (Optical Research Associates). In the ray trace set value section of table (1), EPD is the diameter (unit: mm) of the opening of the aperture stop AS. XAN is the x-direction component (unit: degree) of the angle of incidence to the aperture stop AS of fifteen rays used in ray trace. YAN is the y-direction component (unit: degree) of the angle of incidence to the aperture stop AS of the fifteen rays.

In the lens data section of table (1), RDY indicates the radius of curvature of a surface (vertex radius of curvature for an aspheric surface; unit: mm). THI indicates the distance from the surface to the next surface, or surface interval (unit: mm). RMD indicates whether the surface is a reflection surface or a refraction surface. GLA indicates the medium between the surface and the next surface. REFL indicates a reflection surface. INFINITY indicates infinity. When RDY is INFINITY, that surface is a plane. OBJ indicates the surface of an infinitely distant object serving as an object plane. STO indicates the surface of the aperture stop AS. Surface numbers 2 and 3 indicate virtual ultra-thin lenses that are optically equivalent to the reflection mirror elements of the second fly's eye optical system 18b. Since the second fly's eye optical system 18b can be considered as a whole as being a concave mirror having positive power, the power value is expressed as a virtual ultra-thin lens.

Surface number 4 indicates the reflection surface of the convex reflection mirror 29a. Surface number 5 indicates the reflection surface of the concave reflection mirror 29b. Surface number 6 and IMG indicate the pattern surface of the mask M serving as an image plane. SPS XYP indicates that the surface (surface indicated as surface number 2 in lens data) is a free-form surface expressed by a power series of xy in the equation (1) shown below. The SPS XYP surface is a tenth-order polynomial surface added to a reference Korenich. The polynomial equation is expanded to a monomial equation of x^{m}yⁿ(m+n≦10).

$$\begin{matrix}Equation 1 & \\ s = \frac{{cr}^{2}}{1 + \sqrt{1 - ( 1 + k ) {c}^{2} {r}^{2}}} + {\sum }_{j = 2}^{66} {C}_{j} {x}^{m} {y}^{n} \\ where , \\ j = \frac{\{ {( m + n )}^{2} + m + 3 n \}}{2} + 1 & ( 1 )\end{matrix}$$

In equation (1), s is the sag amount (unit: mm) of a plane parallel to the z-axis, c is the vertex curvature (unit: mm⁻¹), r is the distance from the vertex (value of square root of x²+y²) (unit: mm), k is a Korenich constant, and Cj is a coefficient of monomial equation x^{m}yⁿ. In the lens data section of table (1), K is a Korenich constant k. Y is a coefficient of y, X2 is a coefficient of x², Y2 is a coefficient of y², X2Y is a coefficient of x²y, Y3 is a coefficient of y³, X4 is a coefficient of x⁴, X2Y2 is a coefficient of x²y², Y4 is a coefficient of y⁴, X4Y is a coefficient of x⁴y, X2Y3 is a coefficient of x²y³, and Y5 is a coefficient of y⁵.

In the second fly's eye optical system 18b, each reflection mirror element tilts and provides the power of the optical surface corresponding to the free-form surface to the optical system. However, such state cannot be directly expressed in Code V. A state optically equivalent to each reflection mirror element of the second fly's eye optical system 18b is thus expressed using a virtual ultra-thin lens (corresponding to second surface and third surface in the lens data) formed of glass ‘kari’ having an extremely high index of refraction. The index of refraction of the glass ‘kari’ is 10000.

For the surface numbers 4 to 6, XDE, YDE, and ZDE indicate the x-direction component (unit: mm), the y-direction component (unit: mm), and the z-direction component (unit: mm) of the eccentricity of a surface. Further, ADE, BDE, and CDE indicate the θx-direction component (rotational component about x-axis; unit: degree), θy-direction component (rotational component about y-axis; unit: degree), and θz-direction component (rotational component about z-axis; unit: degree) of the rotation of a surface. For the surface numbers 4 and 5, DAR indicates that the coordinates (x, y, z) after the surface does not change. In other words, even when the surface indicated as DAR is eccentric, the surface rearward to that surface is not in accordance with the new eccentric coordinates and the eccentricity is an independent eccentricity of only the surface indicated as DAR. The indication in table (1) is the same in the following table (2) and table (3).

TABLE (1)
<<< Ray Trace Set Value >>>

| | | | | | |
|---|---|---|---|---|---|
| EPD | 166.40000 | | | | |
| XAN | 0.00000 | 0.00000 | 0.00000 | 0.46553 | 0.46553 |
| | 0.46553 | 0.93110 | 0.93110 | 0.93110 | 1.39672 |
| | 1.39672 | 1.39672 | 1.86244 | 1.86244 | 1.86244 |
| YAN | 4.73228 | 4.87602 | 5.01980 | 4.70990 | 4.85364 |
| | 4.99741 | 4.64215 | 4.78588 | 4.92963 | 4.52707 |
| | 4.67077 | 4.81450 | 4.36106 | 4.50473 | 4.64843 |

<<< Lens Data >>>

| | RDY | THI | RMD | GLA |
|---|---|---|---|---|
| OBJ: | INFINITY | INFINITY | | |
| STO: | INFINITY | 0.000000 | | |
| 2: | 29753283.62 | 0.000000 | | ‘kari’ |

| | | |
|---|---|---|
| SPS XYP: | | |
| K: −3.4368E+08 | Y: −5.7819E−06 | X2: −8.3388E−09 |
| Y2: −8.6408E−09 | X2Y: 2.0799E−12 | Y3: 2.0777E−12 |
| X4: −8.2059E−17 | X2Y2: −2.9658E−16 | Y4: −5.1558E−17 |
| X4Y: −1.1652E−19 | X2Y3: −2.4719E−18 | Y5: −3.0454E−19 |

| | | | |
|---|---|---|---|
| 3: | −29753283.62 | 973.472162 | |
| 4: | 1307.30000 | −788.472162 | REFL |

| | | | | | | |
|---|---|---|---|---|---|---|
| XDE: | 0.000000 | YDE: | 69.285474 | ZDE: | 0.000000 | DAR |
| ADE: | 0.000000 | BDE: | 0.000000 | CDE: | 0.000000 | |

| | | | |
|---|---|---|---|
| 5: | 1593.85000 | 1149.331775 | REFL |

| | | | | | | |
|---|---|---|---|---|---|---|
| XDE: | 0.000000 | YDE: | 145.662143 | ZDE: | 0.000000 | DAR |
| ADE: | 0.000000 | BDE: | 0.000000 | CDE: | 0.000000 | |

| | | |
|---|---|---|
| 6: | INFINITY | 0.000000 |

| | | | | | |
|---|---|---|---|---|---|
| XDE: | 0.000000 | YDE: | 213.343794 | ZDE: | 0.000000 |
| ADE: | 6.378665 | BDE: | 0.000000 | CDE: | 0.000000 |

| | | |
|---|---|---|
| IMG: | INFINITY | 0.000000 |

In FIG. 6, a pupil axis PA is shown by a line segment extending through the center of an exit pupil EP of the illumination optical system in the comparative example perpendicular to a plane of the exit pupil EP. The pupil axis PA substantially coincides with the rotation axis IRa of the arcuate-shape of the illumination region IR formed on the mask M. In FIG. 6, the pupil axis PA intersects with the convex reflection mirror 29a of the condenser optical system and the opening of the aperture stop AS. The rotation axis IRa of the arcuate region IR shown in FIG. 5 and the pupil axis PA substantially coincide with each other. When the entrance pupil of the projection optical system and the exit pupil EP shown in FIG. 6 are located at the same position, the optical axis of the projection optical system, the rotation axis IRa of the arcuate region, and the pupil axis substantially coincide with one another.

The location of the exit pupil of the illumination optical system and the entrance pupil of the projection optical system at the same position includes situations in which they are not located at the same position in a strict sense. In other words, the two only need to be located within a range required by the apparatus specification. A situation in which three axes substantially coincide with one another includes a state in which the axes are separated due to a tolerance allowed to define the above-described rotation axis of the arcuate region or due to the entrance pupil and exit pupil not being located at the same position in a strict sense. When an eccentric optical system is employed as the projection optical system, an optical axis would not exist in a strict sense. However, in such a case, the displacement amounts of mirrors would be small, and each mirror would be arranged along substantially a single axis. Such a single axis may be considered as a substantial optical axis, and such a substantial optical axis substantially coincides with the above-described rotation axis and pupil axis.

FIG. 6 shows a state in which the reflection mirror M1 is arranged closest to the illumination optical system when the exit pupil of the illumination optical system and the entrance pupil of the projection optical system are located at the same position. As apparent from FIG. 6, the reflection mirror M1 of the projection optical system is arranged in the optical path of the illumination optical system. Accordingly, as long as a plane mirror for deflecting the optical path is not arranged between the illumination optical system of the comparative example and the reflective mask, the illumination optical system and the projection optical system cannot be separated when exit pupil of the illumination optical system and the entrance pupil of the projection optical system are located at the same position. This results in mechanical interference between the two systems or overlapping of the optical path, and the functions of an exposure apparatus cannot be achieved. Examples of the present embodiment will hereafter be discussed.

### FIRST EXAMPLE

FIG. 7 is a schematic diagram showing the main structure of an illumination optical system according to a first example. Referring to FIG. 7, the condenser optical system 19 forming the main part of the illumination optical system 2 of the first example is a reflection-type condenser system in which a convex reflection mirror 19a and a concave reflection mirror 19b are arranged in this order with respect to the light received from the aperture stop AS arranged substantially at the same position as the reflection plane of the second fly's eye optical system 18b. The aperture stop AS may be separated from the reflection plane of the second fly's eye optical system 18b by a certain distance. For example, the aperture stop AS may be arranged along the optical axis separated by two millimeters from a position at which the second fly's eye optical system is most projected. In this case, when the separated distance influences the functions of the aperture stop and becomes problematic, the shape may be changed to reduce the influence. For example, a circular shape may be changed to an elliptic shape to reduce the influence. In this specification, a case in which the aperture stop is slightly separated from the second fly's eye optical system (more specifically, the distance between the aperture stop and the second fly's eye optical system is less than or equal to one tenth the diameter of a circle entirely enclosing the reflection plane of the second fly's eye optical system 18b (plurality of reflection mirror elements 18ba)) is also referred to as a state in which the aperture stop and the reflection plane of the second fly's eye optical system are arranged at substantially the same position. FIG. 7 shows a state in which light beam from an infinitely distant object (not shown) passes by the aperture stop AS and the second fly's eye optical system 18b and then by the convex reflection mirror 19a and the concave reflection mirror 19b to form an image on the mask M.

Table (2), which is shown below, lists data values of the main part of the illumination optical system 2 in the first example. In the lens data section of table (2), ASP indicates that the surface (surface of surface numbers 4 and 5 in the lens data) is an aspheric surface represented by the following equation (2).

s=(h²/r)/[1+{1−(1+κ)·h²/r²}^{1/2}]+C₄·h⁴+C₆·h⁶+C₈·h⁸+C₁₀·h¹⁰ (2)

In equation (2), h is the height (unit: mm) in a direction perpendicular to an optical axis, s is the distance (sag amount) (unit: mm) along the optical axis from a tangent plane at the vertex of an aspheric surface to the position on the aspheric surface at height h, r is a vertex curvature radius (unit: mm), κ is a conical coefficient, and Cₙ is an aspheric surface coefficient of the nth order. In the lens data section of table (2), K is a conical coefficient κ, A is a coefficient C₄ of h⁴, B is a coefficient C₆ of h⁶, C is a coefficient C₈ of h⁸, and D is a coefficient C₁₀ of h¹⁰. Further, in the lens data section of table (2), surface number 4 indicates the reflection surface of the convex reflection mirror 19a, and surface number 5 indicates the reflection surface 19b of the concave reflection mirror 19b.

TABLE (2)
<<< Ray Trace Set Value >>>

| | | | | | |
|---|---|---|---|---|---|
| EPD | 166.40000 | | | | |
| XAN | 0.00000 | 0.00000 | 0.00000 | 0.46553 | 0.46553 |
| | 0.46553 | 0.93110 | 0.93110 | 0.93110 | 1.39672 |
| | 1.39672 | 1.39672 | 1.86244 | 1.86244 | 1.86244 |
| YAN | 4.73228 | 4.87602 | 5.01980 | 4.70990 | 4.85364 |
| | 4.99806 | 4.64215 | 4.78588 | 4.93226 | 4.52707 |
| | 4.67077 | 4.82061 | 4.36106 | 4.50473 | 4.65987 |

<<< Lens Data >>>

| | RDY | THI | RMD | GLA |
|---|---|---|---|---|
| OBJ: | INFINITY | INFINITY | | |
| STO: | INFINITY | 0.000000 | | |
| 2: | INFINITY | 0.000000 | | ‘kari’ |

| | | |
|---|---|---|
| SPS XYP: | | |
| Y: 1.3142E−05 | X2: 2.4936E−08 | Y2: 2.4830E−08 |
| X2Y: 1.0718E−13 | X2Y2: −4.5746E−15 | |

| | | | |
|---|---|---|---|
| 3: | INFINITY | 993.569523 | |
| 4: | 1328.06125 | −793.569523 | REFL |

| | | | |
|---|---|---|---|
| ASP: | | | |
| K: 0.000000 | | | |
| A: 0.130995E−09 | B: −0.269561E−13 | C: 0.125038E−17 | D: −0.207780E−22 |

| | | | | | | |
|---|---|---|---|---|---|---|
| XDE: | 0.000000 | YDE: | 35.582377 | ZDE: | 0.000000 | DAR |
| ADE: | 0.000000 | BDE: | 0.000000 | CDE: | 0.000000 | |

| | | | |
|---|---|---|---|
| 5: | 1602.12924 | 1150.000000 | REFL |

| | | | |
|---|---|---|---|
| ASP: | | | |
| K: 0.000000 | | | |
| A: 0.337539E−10 | B: −0.918963E−15 | C: 0.100831E−19 | D: −0.415420E−25 |

| | | | | | | |
|---|---|---|---|---|---|---|
| XDE: | 0.000000 | YDE: | −20.921051 | ZDE: | 0.000000 | DAR |
| ADE: | 0.000000 | BDE: | 0.000000 | CDE: | 0.000000 | |

| | | |
|---|---|---|
| 6: | INFINITY | 0.000000 |

| | | | | | |
|---|---|---|---|---|---|
| XDE: | 0.000000 | YDE: | −280.927289 | ZDE: | 0.000000 |
| ADE: | 7.792657 | BDE: | 0.000000 | CDE: | 0.000000 |

| | | |
|---|---|---|
| IMG: | INFINITY | 0.000000 |

In the illumination optical system 2 of the first example, the condenser optical system 19 is formed by the convex reflection mirror 19a, which has a reflection surface with a rotationally symmetric aspherical shape, and the concave reflection mirror 19b, which has a reflection surface with a rotationally symmetric aspherical shape. The rotation axes of symmetry of the rotation symmetric aspherical surfaces of the convex reflection mirror 19a and the concave reflection mirror 19b are arranged to be angled to and/or separated from a reference axis z, which extends through the center of the opening in the aperture stop AS perpendicular to the surface of the aperture stop AS. The rotation axes of symmetry may intersect the reference axis but do not necessarily have to intersect the reference axis at a single point.

In FIG. 7, a pupil axis of the exit pupil EP in the illumination optical system 2 of the first example is shown by line segment PA. Although not shown in the drawing, as described above, the rotation axis IRa of the arcuate-shape of the illumination region IR formed on the mask M substantially coincides with the pupil axis PA. In FIG. 7, the pupil axis PA or the rotation axis IRa of the arcuate-shape of the illumination region is located outside the opening of the aperture stop AS without intersecting with the convex reflection mirror 19a and concave reflection mirror 19b of the condenser optical system 19. Further, it is apparent that the pupil axis PA of the exit pupil EP or the rotation axis IRa of the arcuate-shape of the illumination region IR is located outside the profiles of the two reflection mirrors forming the condenser optical system, that is, the profile of the convex reflection mirror 19a having a reflection surface with a rotationally symmetric aspherical shape and the profile of the concave reflection mirror 19b having a reflection surface with a rotationally symmetric aspherical shape.

FIG. 7 shows the reflection mirror M1 of the projection optical system arranged closest to the illumination optical system when the entrance pupil of the projection optical system is located at the same position as the exit pupil EP of the illumination optical system. As apparent from FIG. 7, the illumination optical system and projection optical system may be separated from each other even without the plane mirror. In other words, mechanical interference between the projection optical system and the illumination optical system does not occur, and a reflection mirror of the projection optical system is not arranged in the optical path of the illumination optical system.

### SECOND EXAMPLE

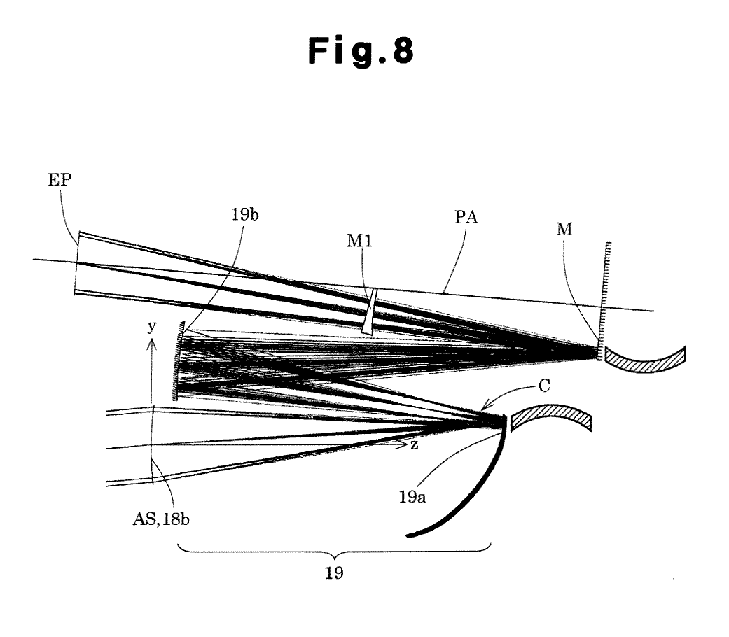

FIG. 8 is a schematic diagram showing the main structure of an illumination optical system according to a second example. Referring to FIG. 8, the condenser optical system 19 forming the main part of the illumination optical system 2 of the second example includes a concave reflection mirror 19a and a concave reflection mirror 19b, which are arranged in this order with respect to the light received from the aperture stop AS arranged substantially at the same position as the reflection plane of the second fly's eye optical system 18b. FIG. 8 shows a state in which light beam from an infinitely distant object (not shown) passes by the aperture stop AS and the second fly's eye optical system 18b and then by the concave reflection mirror 19a and the concave reflection mirror 19b to form an image on the mask M. Table (3), which is shown below, lists data values of the main part of the illumination optical system in the second example. In the lens data section of table (3), surface number 4 indicates the reflection surface of the concave reflection mirror 19a, and surface number 5 indicates the reflection surface of the concave reflection mirror 19b.

TABLE (3)
<<< Ray trace Set Value >>>

| | | | | | |
|---|---|---|---|---|---|
| EPD | 166.40000 | | | | |
| XAN | 0.00000 | 0.00000 | 0.00000 | 0.46553 | 0.46553 |
| | 0.46553 | 0.93110 | 0.93110 | 0.93110 | 1.39672 |
| | 1.39672 | 1.39672 | 1.86244 | 1.86244 | 1.86244 |
| YAN | 4.73228 | 4.87602 | 5.01980 | 4.70990 | 4.85364 |
| | 4.99741 | 4.64215 | 4.78588 | 4.92963 | 4.52707 |
| | 4.67077 | 4.81450 | 4.36106 | 4.50473 | 4.64843 |

<<< Lens Data >>>

| | RDY | THI | RMD | GLA |
|---|---|---|---|---|
| OBJ: | INFINITY | INFINITY | | |
| STO: | 833.13494 | 0.000000 | | |
| 2: | 833.13494 | 0.000000 | | ‘kari’ |

| | | |
|---|---|---|
| SPS XYP: | | |
| K: 4.6188E−05 | Y: 1.3338E−06 | X2: −3.4240E−09 |
| Y2: −3.2735E−09 | X2Y: 6.2076E−13 | Y3: 7.0758E−13 |
| X4: −1.3820E−14 | X2Y2: −3.0355E−14 | Y4: −1.8768E−14 |
| X4Y: 3.0059E−18 | X2Y3: 9.8523E−18 | Y5: 1.2828E−17 |

| | | | |
|---|---|---|---|
| 3: | 833.22730 | 789.807305 | |
| 4: | −364.70403 | −689.810205 | REFL |

| | | | |
|---|---|---|---|
| ASP: | | | |
| K: 0.000000 | | | |
| A: 0.512135E−07 | B: −0.395727E−11 | C: 0.982223E−16 | D: −0.845328E−21 |

| | | | | | | |
|---|---|---|---|---|---|---|
| XDE: | 0.000000 | YDE: | −108.042431 | ZDE: | 0.000000 | DAR |
| ADE: | −38.143024 | BDE: | 0.000000 | CDE: | 0.000000 | |

| | | | |
|---|---|---|---|
| 5: | 960.28537 | 1000.002899 | REFL |

| | | | |
|---|---|---|---|
| ASP: | | | |
| K: 0.000000 | | | |
| A: −0.802933E−10 | B: 0.357499E−15 | C: −0.134622E−20 | D: 0.215556E−26 |

| | | | | | | |
|---|---|---|---|---|---|---|
| XDE: | 0.000000 | YDE: | −140.131266 | ZDE: | 0.000000 | DAR |
| ADE: | 16.050740 | BDE: | 0.000000 | CDE: | 0.000000 | |

| | | |
|---|---|---|
| 6: | INFINITY | 0.000000 |

| | | | | | |
|---|---|---|---|---|---|
| XDE: | 0.000000 | YDE: | 363.354866 | ZDE: | 0.000000 |
| ADE: | −4.128691 | BDE: | 0.000000 | CDE: | 0.000000 |

In the illumination optical system 2 of the second example, the condenser optical system 19 is formed by the concave reflection mirror 19a, which has a reflection surface with a rotationally symmetric aspherical shape, and the concave reflection mirror 19b, which has a reflection surface with a rotationally symmetric aspherical shape. The rotation axes of symmetry of the rotation symmetric aspherical surfaces of the concave reflection mirror 19a and the concave reflection mirror 19b are arranged to be angled to and/or separated from a reference axis z, which extends through the center of the opening in the aperture stop AS perpendicular to the surface of the aperture stop AS. The rotation axes of symmetry may intersect the reference axis but do not necessarily have to intersect the reference axis at a single point.

In FIG. 8, a pupil axis of the exit pupil EP in the illumination optical system 2 of the second example is shown by line segment PA. In the same manner as the first embodiment, the rotation axis IRa of the arcuate-shape of the illumination region IR substantially coincides with the pupil axis PA. In FIG. 8, the pupil axis PA or the rotation axis IRa of the arcuate-shape of the illumination region is located outside the opening of the aperture stop AS without intersecting with the concave reflection mirror 19a and concave reflection mirror 19b of the condenser optical system 19. Further, it is apparent that the pupil axis PA of the exit pupil EP or the rotation axis IRa of the arcuate-shape of the illumination region IR is located outside the profiles of the two reflection mirrors forming the condenser optical system, that is, the profile of the concave reflection mirror 19a having a reflection surface with a rotationally symmetric aspherical shape and the profile of the concave reflection mirror 19b having a reflection surface with a rotationally symmetric aspherical shape.

FIG. 8 shows the reflection mirror M1 of the projection optical system arranged closest to the illumination optical system when the entrance pupil of the projection optical system is located at the same position as the exit pupil EP of the illumination optical system. As is apparent from FIG. 8, the illumination optical system and projection optical system may be separated from each other even without the plane mirror. In other words, mechanical interference between the projection optical system and the illumination optical system does not occur, and a reflection mirror of the projection optical system is not arranged in the optical path of the illumination optical system.

Further, in the illumination optical system 2 of the second example, the condenser optical system 19 forms a position C optically conjugated with the mask M in the optical path between the second fly's eye optical system 18b (and consequently, the aperture stop AS) and the mask M, and more specifically, in the optical path between the second fly's eye optical system 18b and the concave reflection mirror 19a. Additionally, the arcuate-shapes formed at position C and on the mask M face opposite directions as shown in the drawing. Thus, the condenser optical system 19 functions as an imaging optical system that forms an erected image of the arcuate illumination region on the mask M at the conjugated position C. In this manner, since the arcuate regions face opposite directions, the distance between the rotation axes IRa of the two arcuate regions may be relatively increased. Each optical element of the illumination optical system or projection optical system may be arranged along the rotation axes IRa. Accordingly, employment of the optical system of the present example that forms an erected image facilitates separation of the projection optical system and the illumination optical system. In other words, separation of the optical path of the projection optical system from the optical path of the illumination optical system and prevention of mechanical interference between optical elements is further ensured. When using an eccentric optical system as described above, the reflection mirrors are arranged substantially along a single axis. This facilitates separation of the illumination optical system and projection optical system.

Further, in the second example, in lieu of part of or all of the aperture stop 21 arranged near the mask or in addition to part of or all of the aperture stop 21, an aperture stop may be arranged at a conjugated position between the second fly's eye optical system 18b and the concave reflection mirror 19a.

In the first example and second example, among the two reflection mirrors 19a and 19b of the condenser optical system 19, the reflection mirror 19b arranged closest to the mask (illuminated surface) M along the optical path has a reflection surface with a concave shape. When proceeding opposite the traveling direction of the light from the mask M, light beam spread out as they reach the reflection mirror 19b. Thus, when the reflection surface of the reflection mirror 19b has a concave shape, the condenser optical system 19, and consequently, the illumination optical system 2, may be designed to be compact.

In the two reflection mirrors 18a and 19b of the condenser optical system 19 in the first and second examples, the rays entering the two reflection surfaces and normal lines of the optical surfaces at the incident positions of the rays form angles having a maximum value of less than thirty degrees. More specifically, the maximum value of the above angle is 8.3 degrees in the first example, and the maximum value of the above angle is 12.7 degrees in the second embodiment. In this manner, the maximum values of the angles formed between the rays entering the two reflection surfaces of the condenser optical system 19 and normal lines of the optical surfaces are kept less than 30 degrees so that the condenser optical system 19 has a high reflectivity.

In the first example and second example, to change the illumination conditions, aperture stops may include openings of various shapes, such as, multipole openings (e.g., dipole openings and quadrupole openings) and annular-shaped openings. In such a case, it is important that the pupil axis of the exit pupil of the illumination optical system 2 (and consequently, the rotation axis IRa of the arcuate-shape of the illumination region) be located outward from the outermost part of the opening of the aperture stop (multipole openings and annular-shaped openings).

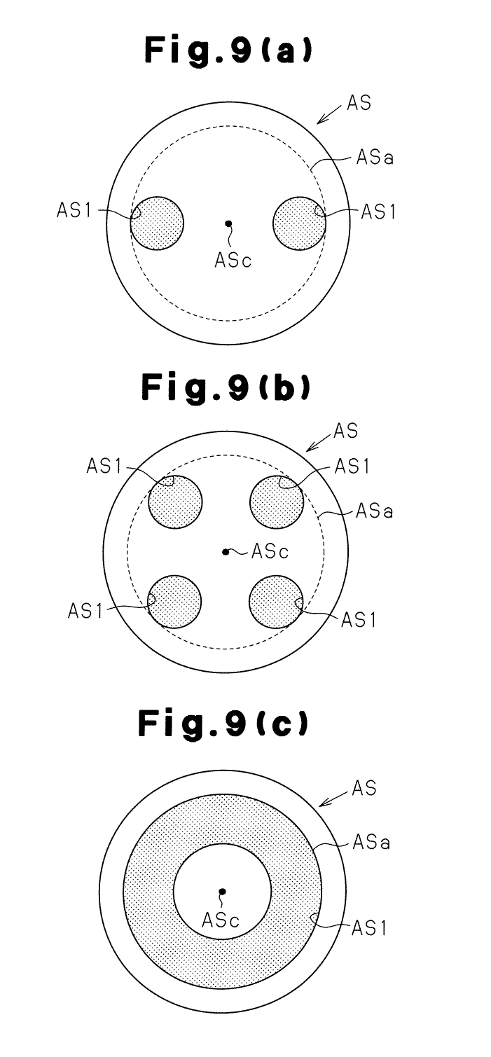

More specifically, as shown in FIGS. 9(a) to 9(c), when the aperture stop AS has dipole, quadrupole, or annular-shaped openings AS1 (shaded portion in the drawings), it is important that the pupil axis be located outward from the outermost portion of a circle ASa circumscribing the dipole, quadrupole, or annular-shaped opening AS1. In this specification, the circles ASa circumscribing the openings AS1 of various shapes are defined as the openings of substantial aperture stops. The center of the exit pupil of the illumination optical system is defined as the center of the image of the circuit ASa (i.e., the image of the center ASc of the circuit ASa). When the aperture stop cannot be viewed as a plane, the center of the opening may be defined as the center of the exit pupil in the same manner as, for example, a concave surface or convex surface.

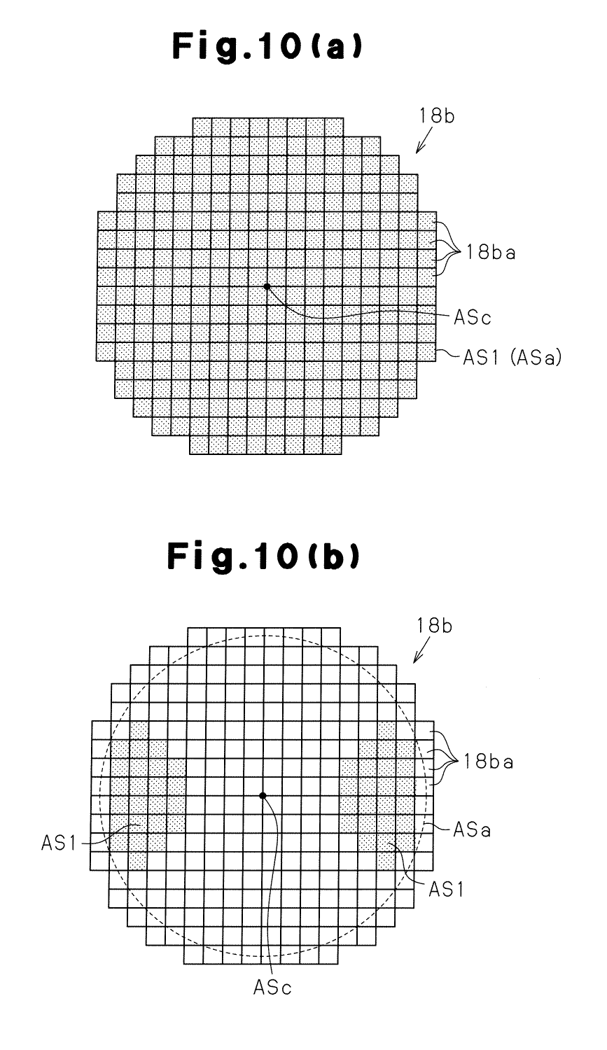

In the first example and second example, the aperture stop AS functions as the opening ASa of a substantial aperture stop. However, the second fly's eye optical system 18b may function as the opening ASa of a substantial aperture stop. For example, as shown in FIG. 10(a), the plurality of reflection mirror elements 18ba of the second fly's eye optical system 18b may entirely function as the opening ASa of a substantial aperture stop. In the example of FIG. 10(b), when employing a technique for guiding light to a plurality of local regions in the second fly's eye optical system 18b (for example, see U.S. Pat. No. 6,452,661, U.S. Pat. No. 6,704,095, U.S. Patent Application Publication No. US2004/0119961A1, and U.S. Patent Application Publication No. 2007/0132977A1, which are incorporated herein by reference), the plurality of local regions each function as an opening AS1, and a circle circumscribing the plurality of local regions AS1 functions as the opening ASa of a substantial aperture stop. In other words, part of the second fly's eye optical system 18b functions as the opening ASa of a substantial aperture stop.

Therefore, in the specification of the present application, the term “substantial aperture stop” refers to an aperture angle restriction member which is arranged in the illumination optical path and which restricts the aperture angle of the light beam illuminating the illuminated surface (mask M), for example, the aperture stop AS and part of or all of the second fly's eye optical system 18b.

In the first and second examples described above, rotation symmetric aspherical surfaces are used as the two reflection mirrors of the condenser optical system. However, free-form surfaces may also be used. When using a free-form surface, a rotation axis of symmetry will not exist. However, when using a free-form surface having a center axis, the center axis may be separated from a reference axis extending through the center of the aperture stop.

The EUVL exposure apparatus of the above embodiment uses a laser plasma light source as a light source for supplying EUV light. However, the present invention is not limited in such a manner, and other appropriate light sources for supplying EUV light may be used, for example, a synchrotron radiation (SOR) light source or a discharge plasma light source.

In the above embodiment, instead of the reflective mask, a pattern formation device for forming a predetermined pattern based on predetermined electronic data may be used. A reflective type spatial light modulator including a plurality of reflection elements driven based on, for example, predetermined electronic data may be used as the pattern formation device. Exposure apparatuses using reflective type spatial light modulators are disclosed in, for example, Japanese Laid-Open Patent Publication Nos. 8-313842 and 2004-304135.

In the exposure apparatus of the above embodiment, various sub-systems including the elements cited in the claims of the present application are assembled and manufactured to as to maintain predetermined mechanical accuracies, electrical accuracies, and optical accuracies. Before and after the assembling, optical systems undergo adjustments to obtain the necessary optical accuracies, mechanical systems undergo adjustments to obtain the necessary mechanical accuracies, and electrical systems undergo adjustments to obtain the necessary electrical accuracies. A process for assembling the exposure apparatus with the various sub-systems includes carrying out mechanical connections, electric circuit wire connections, and gas circuit pipe connections between the sub-systems. Prior to the process for assembling the exposure apparatus with the various sub-systems, it is obvious that there are processes for assembling each sub-system. After assembling the exposure apparatus with the sub-systems, general adjustments are carried out so as to ensure various accuracies of the exposure apparatus as a whole. The exposure apparatus may be manufactured in a clean room of which temperature, cleanness, and the like are controlled.

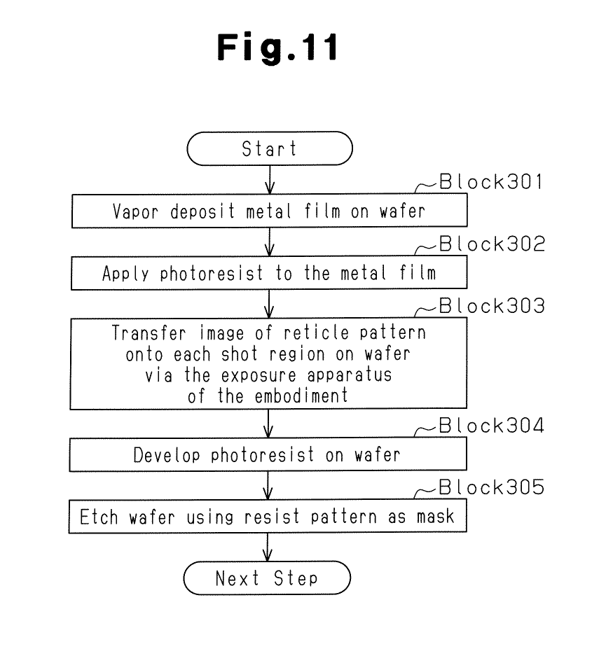

In the exposure apparatus according to the above-described embodiment, a micro-device (e.g., semiconductor device, imaging device, liquid crystal display device, and thin-film magnetic head) may be manufactured by illuminating a mask with an illumination system (illumination process) and exposing a transfer pattern formed on the mask onto a photosensitive substrate with a projection optical system (exposure process). One example of the procedures for obtaining a semiconductor device serving as a micro-device by forming a predetermined circuit pattern on a wafer or the like, serving as the photosensitive substrate, with the exposure apparatus of the present embodiment will be described with reference to the flowchart of FIG. 11.

First, in block 301 of FIG. 11, a metal film is vapor deposited on a single lot of wafers. Next, in block 302, photoresist is applied to the metal film on the single lot of wafers. Then, in block 303, the image of a pattern on a mask (reticle) is sequentially exposed and transferred to each shot region in the single lot of wafers with the projection optical system of the exposure apparatus of the present embodiment.

After the photoresist on the single lot of wafers is developed in block 304, etching is carried out on the single lot of wafers using a resist pattern as the mask in block 305 so that a circuit pattern corresponding to the pattern on the mask is formed in each shot region of each wafer. The circuit pattern or the like of an upper layer is then formed to manufacture a device such as a semiconductor device. The above-described semiconductor device manufacturing method obtains semiconductor devices having extremely fine circuit patterns with a satisfactory throughput. In blocks 301 to 305, metal is vapor deposited on wafers and resist is applied to films of the metal. Further, exposure, development, and etching blocks are performed. However, prior to these blocks, after forming a silicon oxide film on the wafers, it is obvious that resist may be applied to the silicon oxide film, and then blocks such as exposure, development, and etching can be performed

The invention is not limited to the foregoing embodiments and various changes and modifications of its components may be made without departing from the scope of the present invention. Also, the components disclosed in the embodiments may be assembled in any combination for embodying the present invention. For example, some of the components may be omitted from all components disclosed in the embodiments. Further, components in different embodiments may be appropriately combined.

What is claimed is:

1. A reflection-type illumination optical system for guiding illumination light to an arcuate-shape region on an illuminated surface, the illumination optical system comprising:
an aperture angle restriction member which is arranged in an illumination optical path and which restricts an aperture angle of light beam illuminating the illuminated surface; and
a reflection-type condenser optical system which is arranged in an optical path between the aperture angle restriction member and the illuminated surface and which guides the light beam from the aperture angle restriction member to the illuminated surface;
wherein the arcuate-shape includes a rotation axis located outside an opening of the aperture angle restriction member; and
the reflection-type condenser optical system includes a plurality of reflection surfaces, and among the plurality of reflection surfaces, the reflection surface closest to the illuminated surface along the optical path is shaped to be concave.

2. The illumination optical system according to claim 1, wherein the reflection-type condenser optical system consisting of two reflection surfaces.

3. The illumination optical system according to claim 2, wherein the two reflection surfaces are each concave surfaces.

4. The illumination optical system according to claim 3, wherein rays entering the two reflection surfaces and normal lines of optical surfaces at incident positions of the rays form angles including a maximum value of less than thirty degrees.

5. The illumination optical system according to claim 1, wherein the reflection-type condenser optical system forms a position that is optically conjugated to the illuminated surface in the optical path between the aperture angle restriction member and the illuminated surface.

6. The illumination optical system according to claim 1, wherein the reflection surface includes a rotationally symmetric aspherical shape.

7. The illumination optical system according to claim 1, further comprising:
a first fly's eye optical system including a plurality of first mirror elements arranged in parallel; and
a second fly's eye optical system including a plurality of second mirror elements arranged in parallel between the first fly's eye optical system and the reflection-type condenser optical system so that each of the second mirror elements is associated with one of the first mirror elements;
wherein the reflection-type condenser optical system is formed so that light from each of the plurality of second mirror elements illuminates the illuminated surface in a superimposed manner.

8. The illumination optical system according to claim 7, wherein the aperture angle restriction member is arranged at substantially the same position as a reflection surface of the second fly's eye optical system.

9. The illumination optical system according to claim 7, wherein the aperture angle restriction member is separate from the second fly's eye optical system by a distance of one tenth or less of the diameter of a circle entirely enclosing the plurality of second mirror elements in the second fly's eye optical system.

10. The illumination optical system according to claim 1, wherein a center axis of the aperture angle restriction member and the rotation axis of the arcuate-shape are angled with respect to each other.

11. The illumination optical system according to claim 1, wherein the rotation axis of the arcuate-shape is arranged outside a profile of a reflection mirror that forms a reflection surface of the reflection-type condenser optical system.

12. A reflection-type illumination optical system for guiding illumination light to a region including a predetermined shape on an illuminated surface, the illumination optical system comprising:
an aperture angle restriction member which restricts an aperture angle of light beam illuminating the illuminated surface and which is arranged in an illumination optical path; and
a reflection-type condenser optical system which is arranged in an optical path between the aperture angle restriction member and the illuminated surface and which guides the light beam from the aperture angle restriction member to the illuminated surface;
wherein a pupil axis extending through the center of an exit pupil of the illumination optical system perpendicular to a plane of the exit pupil is located outside an opening of the aperture angle restriction member; and
the reflection-type condenser optical system includes a plurality of reflection surfaces, and among the plurality of reflection surfaces, the reflection surface closest to the illuminated surface along the optical path is shaped to be concave.

13. The illumination optical system according to claim 12, wherein the reflection-type condenser optical system includes two reflection surfaces.

14. The illumination optical system according to claim 13, wherein the two reflection surfaces are each concave surfaces.

15. The illumination optical system according to claim 13, wherein rays entering the two reflection surfaces and normal lines of optical surfaces at incident positions of the rays form angles including a maximum value of less than thirty degrees.

16. The illumination optical system according to claim 12, wherein the reflection-type condenser optical system forms a position that is optically conjugated to the illuminated surface in the optical path between the aperture angle restriction member and the illuminated surface.

17. The illumination optical system according to claim 12, wherein the reflection surface includes a rotationally symmetric aspherical shape.

18. The illumination optical system according to claim 12, further comprising:
a first fly's eye optical system including a plurality of first mirror elements arranged in parallel; and
a second fly's eye optical system including a plurality of second mirror elements arranged in parallel between the first fly's eye optical system and the reflection-type condenser optical system so that each of the second mirror elements is associated with one of the first mirror elements;
wherein the reflection-type condenser optical system is formed so that light from each of the plurality of second mirror elements illuminates the illuminated surface in a superimposed manner.

19. The illumination optical system according to claim 18, wherein the aperture angle restriction member is arranged at substantially the same position as a reflection surface of the second fly's eye optical system.

20. The illumination optical system according to claim 18, wherein the aperture angle restriction member is separate from the second fly's eye optical system by a distance of one tenth or less of the diameter of a circle entirely enclosing the plurality of second mirror elements in the second fly's eye optical system.

21. The illumination optical system according to claim 12, wherein a center axis of the aperture angle restriction member and the pupil axis are angled with respect to each other.

22. The illumination optical system according to claim 12, wherein the pupil axis is arranged outside a profile of a reflection mirror that forms a reflection surface of the reflection-type condenser optical system.

23. An illumination optical system for guiding illumination light to an arcuate-shape region on an illuminated surface, the illumination optical system comprising:
a first fly's eye optical system including a plurality of first mirror elements arranged in parallel; and
a second fly's eye optical system including a plurality of second mirror elements arranged in parallel so that each of the second mirror elements is associated with one of the first mirror elements of the first fly's eye optical system; and
a condenser optical system which guides light from each of the plurality of second mirror elements to the region including the arcuate-shape in a superimposed manner and which forms a position that is conjugated to the illuminated surface in an optical path between the second fly's eye optical system and the illuminated surface.

24. The illumination optical system according to claim 23, wherein the condenser optical system is formed so as to reverse the relationship between the illuminated surface and the position that is conjugated to the illuminated surface.

25. The illumination optical system according to claim 23, wherein the condenser optical system includes a plurality of reflection surfaces, and among the plurality of reflection surfaces, the reflection surface closest to the illuminated surface along the optical path is shaped to be concave.

26. The illumination optical system according to claim 23, wherein the condenser optical system is a reflection-type condenser optical system including two reflection surfaces.

27. The illumination optical system according to claim 26, wherein the two reflection surfaces are each concave surfaces.

28. The illumination optical system according to claim 27, wherein rays entering the two reflection surfaces and normal lines of optical surfaces at incident positions of the rays form angles including a maximum value of less than thirty degrees.

29. The illumination optical system according to claim 23, wherein the reflection surface includes a rotationally symmetric aspherical shape.

30. The illumination optical system according to claim 23, further comprising an aperture angle restriction member arranged at substantially the same position as a reflection surface of the second fly's eye optical system.

31. The illumination optical system according to claim 23, further comprising an aperture angle restriction member separated from the second fly's eye optical system by a distance of one tenth or less of the diameter of a circle entirely enclosing the plurality of second mirror elements in the second fly's eye optical system.

32. An illumination optical apparatus comprising:
a light source which supplies illumination light including a wavelength of 5 nm to 50 nm; and
the illumination optical system according to claim 1 which guides the illumination light from the light source to an illuminated surface.

33. An exposure apparatus for exposing a pattern arranged on an illuminated surface onto a photosensitive substrate, the exposure apparatus comprising:
the illumination optical apparatus according to claim 32.

34. A device manufacturing method comprising:
exposing a pattern onto a photosensitive substrate with the exposure apparatus according to claim 33;
developing the photosensitive substrate onto which the pattern has been transferred and forming on a surface of the photosensitive substrate a mask layer shaped in correspondence with the pattern; and
processing the surface of the photosensitive substrate through the mask layer.

35. An illumination optical apparatus comprising:
a light source which supplies illumination light including a wavelength of 5 nm to 50 nm; and
the illumination optical system according to claim 12 which guides the illumination light from the light source to an illuminated surface.

36. An exposure apparatus for exposing a pattern arranged on an illuminated surface onto a photosensitive substrate, the exposure apparatus comprising:
the illumination optical apparatus according to claim 35.

37. A device manufacturing method comprising:
exposing a pattern onto a photosensitive substrate with the exposure apparatus according to claim 36;
developing the photosensitive substrate onto which the pattern has been transferred and forming on a surface of the photosensitive substrate a mask layer shaped in correspondence with the pattern; and
processing the surface of the photosensitive substrate through the mask layer.

38. An illumination optical apparatus comprising:
a light source which supplies illumination light including a wavelength of 5 nm to 50 nm; and
the illumination optical system according to claim 23 which guides the illumination light from the light source to an illuminated surface.

39. An exposure apparatus for exposing a pattern arranged on an illuminated surface onto a photosensitive substrate, the exposure apparatus comprising:
the illumination optical apparatus according to claim 38.

40. A device manufacturing method comprising:
exposing a pattern onto a photosensitive substrate with the exposure apparatus according to claim 39;
developing the photosensitive substrate onto which the pattern has been transferred and forming on a surface of the photosensitive substrate a mask layer shaped in correspondence with the pattern; and
processing the surface of the photosensitive substrate through the mask layer.
